(19) United States
(12) Patent Application Publication
(10) Pub. No.: US 2007/0262743 A1
(43) Pub. Date: Nov. 15, 2007

(54) Linking Mechanism Of Interlock Members For Robot

(76) Inventors: Toru Kono, Chiba (JP); Chihiro Uemura, Chiba (JP)

Correspondence Address: QUARLES & BRADY LLP, 411 E. WISCONSIN AVENUE, SUITE 2040, MILWAUKEE, WI, 53202-4497, US

(21) Appl. No.: 11/748,169

(22) Filed: May 14, 2007

(30) Foreign Application Priority Data
May 15, 2006 (JP) 2006-135552

(51) Int. Cl. G05B 1/06

(52) U.S. Cl. 318/661

(57) ABSTRACT

A linking interlock mechanism in a biped robot is provided that prevents the reduction gears in the servo device from being damaged due to an external impulsive force. A servo horn is fit to the output shaft protruded from a servo device housing, which includes a motor, reduction gears, and the like. An interlock member for transmitting force externally is press fitted on the junction surface of the servo horn with the locking screw inserted via the washer. Salient portions are formed on the junction surface between the servo horn and the interlock member. The interlock member has depressed portions at the positions engaged with the salient portions. When a strong impulse force is externally added to the interlock member, the linking state between the interlock member and the servo horn is released instantaneously. This can prevent the reduction gears in the servo device from being damaged.

### CROSS REFERENCE TO RELATED APPLICATION

This application claims the priority benefit of Japanese Patent Application No. 2006-135552 filed on May 15, 2006.

### STATEMENT REGARDING FEDERALLY SPONSORED RESEARCH

Not Applicable

### BACKGROUND OF THE INVENTION

1. Field of the Invention

The present invention relates to a linking mechanism of interlock members for a robot for realizing various movements according to a program that executes command data received for predetermined purposes and predetermined operations. More particularly, the present invention relates to a biped or walking robot that employs such a linking mechanism and is less prone to breakages.

2. Description of the Related Art

As is well known, a robot, which perform predetermined movements based on data recorded in a microcomputer or based on commands remotely transmitted, normally includes a servo mechanism that interconnects a number of actuators, each having a motor as a drive source, in a predetermined pattern to obtain a certain predetermined purpose.

FIG. 6 is a cross sectional view illustrating an example of a servo device acting as a drive source for a servo mechanism and shows the inside of a nearly cuboid housing 30.

Referring FIG. 6, numeral 31 represents a small dc motor (hereinafter merely referred to as a motor). A reduction gear shaft 34, to which a plurality of reduction gears is mounted, is disposed in the intermediate portion between a motor shaft 32 and a servo output shaft 33. In brief, rotational force of the motor 31 is transmitted to the output shaft 33 via a group of the plural reduction gears, namely four gears in this example, which are fit to the motor shaft 32, the output shaft 33, and the reduction gear 34.

In the housing, the output shaft 33 is connected to a potentiometer 35 for detecting its rotational angle and gears. A servo device is constructed such that the rotational angle of the output shaft 33 is controlled by feeding the rotational angle of the potentiometer 35 back to a drive system circuit.

In some instance, an opening for taking out a power source cord (not shown) may be formed in the housing 30 to dispose a drive substrate circuit in the housing 30.

Such a servo device is used at various portions in servo mechanisms of radio controlled devices. In such a servo device, an output end plate which is called a rotational flange or a servo horn for connecting an arm or frame acting as an actuator is attached to a protruded portion of the output shaft 33.

It has been attempted to produce a robot that can perform a manner of human walking or various movements, namely a human-type biped robot, using the servo devices. Some people are interest in such a robot as a new hobby.

However, a human-type robot or a biped robot imitating an animal has to use plural servo devices to implement the movements of joints of an animal. In some cases, a servo unit having the output shafts of integrated two servo devices is required.

A robot implementing more complicated movements requires articulated plural servo devices and a smaller servo unit acting as a drive source.

A biped robot imitating a human or an animal is controlled with a program which executes to move around freely in a walking space or effect predetermined movements by exerting a force against a specific object. Thus, the robot is often subjected to move unintentionally due to an obstacle or step in a moving space, which makes the robot to fall down or experience an unexpected shock from the outside.

Particularly, when the biped robot experiences a strong outer impulse due to falling down, the struck frame or arm may be damaged. As a matter of fact, the external impulse is transmitted to the output shaft 33 of the servo device via the frame or arm.

The output shaft 33 is normally connected to the rotational shaft of a motor via reduction gears. Particularly, in a small servo device, the impulse applied externally is exerted to the reduction gear approximate to a final stage, and damages the gears in the servo device.

FIG. 7 shows a prior art for use in reducing a damage of the reduction gears in a servo device due to an outer impulse force. As shown in FIG. 7, depressed portions 43a are formed in a circumferential surface on an inner peripheral side of a final stage gear 42 on an output line 41 of a reduction gear (not shown). The depressed portion 43a is called a fitting portion 43. A buffer 44 having salient portions 44a on its circumferential surface is fitted to the fitting portion 43.

Salient portions 45a formed on the side surface of an output shaft 45 are respectively inserted into holes 44b along the circumferential line opened in a buffer 44. Thus, the rotational force of the output line 41 is transmitted to the output shaft 45 and an interlock portion 46 formed integrally to the output shaft 45 rotates.

In the servo device of the prior art, the motor for transmitting the rotational force to the output line 41 rotates the final stage gear 42 via a reduction gear (not shown). The rotational force of the final stage gear 42 drives the output shaft 45 and the interlock portion 46 via the buffer 44. If a strong external impulse applied to the interlock portion 46, the coupling of depressed and salient portion (43a, 44a) between the buffer 44 and the fitting portion 43 in the final stage gear 42 is released due to slip. Thus, a damage of the reduction gears articulated to the final stage gear 42 and the output line 41 is prevented.

FIG. 8 shows a linking structure for transmitting a rotational force of a motor driven actuator to a socket as a part of a robot. An output shaft 52 of an actuator 51 fixed to the robot body is coupled to a ring 53 fixed to the shaft and the frame 55 acting as a socket via a stopper 54 which is made of a resilient material, such as a rubber, and pressed in against the ring 53.

Accordingly, when the small motor in the actuator 51 fixed to the robot body (not shown) is driven, the rotational force causes the output shaft 52 to rotate via the reduction gear mounted in the actuator. The rotation of the output shaft 52 moves the frame 55 to the robot body via a clutch mechanism which is formed of the metal ring 53 and the resilient stopper 54.

In the embodiment shown in FIG. 8, the frame 55 is, for example, a lower jaw of an animal. A movement simulating to bite things is done with the frame 55 and an upper jaw. However, when a biting force beyond a certain degree of biting force is transmitted to the frame 55 forming the lower jaw, the biting force beyond such a degree is cut by the clutch having a limiting mechanism. Thus, it is possible to eliminate a trouble that a thing pinched with the lower jaw is crunched and damaged.

Generally, in a servo device used in robot mechanisms, the motor section acting as a drive force and the reduction gear group are disposed in the housing. The conventional method of protecting the gears in the servo device by means of the buffer 44 explained herein above requires to remove the servo device including the motor and reduction gears from the robot and to disassemble the servo device and to exchange the damaged gear for a new gear at every time when the gear is damaged due to an impulse force. Accordingly, in a mechanism, such as a robot, having the possibility of experiencing an outer shock, much time is required for maintenance of the mechanism.

Moreover, in the prior art the resilient buffer 44 explained herein above has to be added as parts of a transmission mechanism. As a result, the cost of the servo motor becomes high as compared with a conventional general purpose servo device.

As shown in FIG. 8, the mechanism for merely connecting mechanically the actuator and the frame mechanism acting as a robot operating portion with a slip mechanism using the resilient material 54 is capable of preventing a damage of the reduction gear in the servo device. However, the frame mechanism driven by the actuator merely performs a predetermined operation via the slip mechanism. Accordingly, this mechanism is used when the relative control position between the frame mechanism and the actuator is not required.

Therefore, the conventional mechanism merely having the slip mechanism always involves a risk of an erroneous operation and lacks its reliability, if it is used in a joint mechanism that moves arms and legs of a robot to predetermined positions by the servo device.

### SUMMARY OF THE INVENTION

The present invention is made to improve the above-mentioned problems. A linking mechanism of interlock members for a robot according to the present invention comprises a servo device, a servo horn connected to an output shaft of the servo device, and an interlock mechanism press connected to the servo horn with a washer. A junction surface between the interlock member and the servo horn is press engaged with a depressed or salient portion disposed circumferentially on the junction surface.

According to the present invention, the depressed or salient portion comprises hemispherical salient portions formed on the outer junction surface of the servo horn and conical depressed portions formed on the inner junction surface of the interlock member. The washer member is made of a circular synthetic resin material.

The servo horn and the interlock member are press fit with locking screws screwed into the output shaft through the center of the washer member. The rotational positions of the frame or arm acting as an interlock member and the output shaft of a servo device can be easily set.

In the interlock member linking mechanism of the present invention, the interlock member moderates instantaneously the liking state even when a strong shock is applied externally so as to prevent a failure of the servo device. Accordingly, the present invention can be easily adapted to biped robots that require a large number of joints.

According to the present invention, the linking mechanism of interlock members for a robot can prevent the reduction gear in a servo device for controlling the movement of the interlock members from being damaged when a strong impulse force is applied to the frame or arm to move a robot. Moreover, the linking mechanism can be simply restored in its original state even when the mechanical positional relation is displaced due to the impulse.

### BRIEF DESCRIPTION OF THE DRAWINGS

FIG. 1 is an exploded perspective view illustrating a liking mechanism of interlock members for a robot according to the present invention;

FIG. 2 is a cross sectional view illustrating an assembly of the members shown in FIG. 1;

FIG. 3(a) is a front view illustrating a linking member, FIG. 3(b) is a side view illustrating a linking member, FIG. 3(c) is a back view illustrating a linking member, and FIG. 3(d) is a cross-sectional view illustrating a linking member;

FIG. 4(a) is a left (outer) side view illustrating an interlock member, FIG. 4(b) is a left (inner) side view illustrating an interlock member, FIG. 4(c) is a front view illustrating an interlock member, FIG. 4(d) is a lower side view illustrating an interlock member, and FIG. 4(f) is a right side view illustrating an interlock member;

FIG. 5 is an overall model view showing an example of a biped robot;

FIG. 6 is a cross-sectional view illustrating a servo device and showing an aspect of a motor shaft and an output shaft;

FIG. 7 is a perspective view explaining a conventional frame interlock mechanism for a robot;

FIG. 8 is an explanatory view showing an example of an actuator used in a conventional robot servo mechanism.

### DETAILED DESCRIPTION OF THE INVENTION

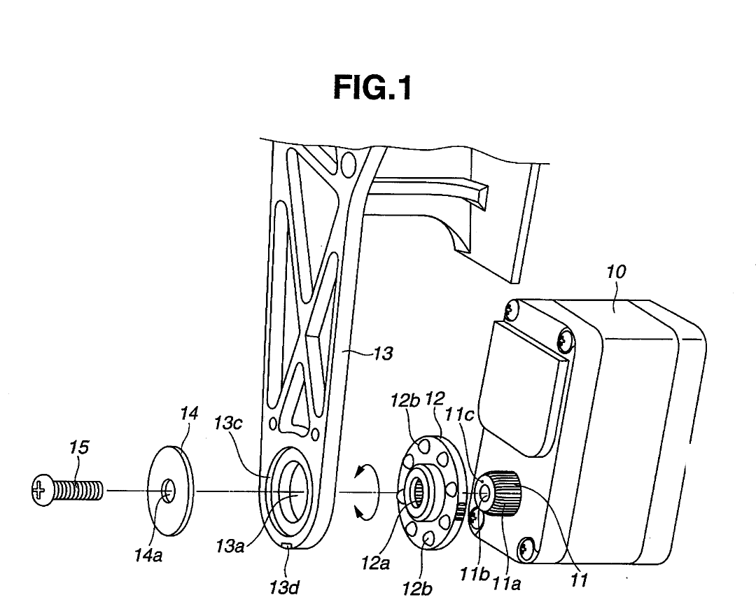

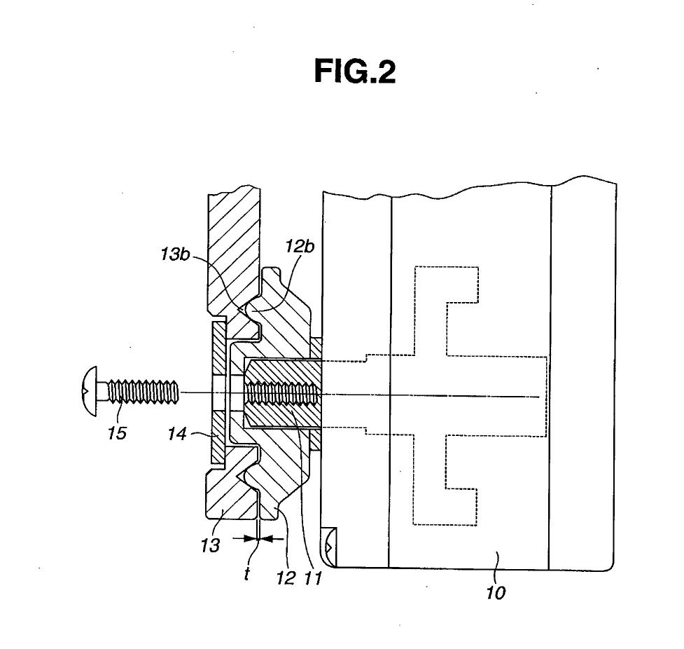

FIGS. 1 and 2 illustrate a linking mechanism of interlock members for a robot according to the present invention. FIG. 1 is an exploded perspective view illustrating condition prior to assembling various members. FIG. 2 is a cross-sectional view illustrating a mechanism for linking an interlock member and an output shaft.

Referring to FIGS. 1 and 2, numeral 10 represents a servo device housing. The servo device housing includes a drive dc motor or a brushless motor and a group of reduction gears for externally transmitting the rotational force thereof.

The output shaft of the servo device providing rotational displacements in two axial directions by means of a linking member proposed previously by the present applicant, can be adapted as the output shaft of the servo device providing the rotational displacement.

A serration 11a having an engraved roughness for transmitting a rotational force is formed on the surface of the output shaft 11 of the servo device. A female screw hole 11b is formed in the center of the serration 11a and a locking screw is screwed into the female screw hole 11b. A linking member 12 is fitted to the output shaft 11 which is usually called a servo horn (hereinafter referred to as a servo horn 12).

The servo horn 12 is attached to link the output shaft 11 and the interlock member 13 acting as an actuator. The servo horn 12 is usually molded with a disc-shaped synthetic resin material having a center hole 12a which has groves slidably engaging with the serration 11a. However, the servo horn may be formed in various shapes according to an application of the servo device.

In the servo horn 12 of the embodiment of the present invention, there is a hole 12b in the center, and hemispheric portions 12b are formed circumferentially on the junction surface as shown in FIG. 2. In the embodiment, eight hemispheric portions 12b, for example, are formed circumferentially at positions where they are engaged with the depressed portions 13b shown in FIG. 2 formed in the interlock member 13, which will be explained later.

The interlock member 13 has an opening 13a for receiving the rotational shaft. A stepped portion 13c is formed around the opening 13a to rest the washer 14. However, the interlock member may be formed in various shapes through the synthetic resin extrusion molding and may be called a frame or arm. The edge portion (not shown) acting as an operation part can implement various operations.

However, when joints in a robot are formed, another servo device may be further mounted to the other end of the interlock member 13 to construct an actuator rotating in two directions.

Eight conical or pyramidal depressed portions 13b (FIG. 2), for example, are formed at intervals of 45 degrees at the positions engaging with the salient portions 12a on the back surface of the interlock member 13 and around the fringe of the opening 13a.

A washer 14 fixes integrally the interlock member 13 to the servo horn 12. A locking screw 15 passes through the hole 14a of the washer 14 and thus pressure fixes the interlock member 13 and the servo horn 12 to the output shaft 1.

In the present embodiment, a POM (polyacetal) resin is used to provide a small resilient force for the washer 14. However, the washer may be formed of other resin materials having a suitable resilient force or may be formed of a metallic disc spring or spring washer.

The linking mechanism of interlock members for a robot of the present invention is constructed as explained hereinabove. Accordingly, as shown with the cross-sectional view in FIG. 2, the servo horn 12 is fit into the output shaft 11. The interlock member 13 is superposed to the servo horn 12 and is securely fastened to the output shaft 11 of the servo device 10 via the washer 14 by means of the locking screw 15.

In this structure, the salient portions 12b of the servo horn 12 are fixed such that they are received in the depressed portions 13b of the interlock member 13. However, it is desirable to design the linking mechanism to have a small gap t between the junction surface of the interlock member 13 and the junction surface of the servo horn 12, when the locking screw 15 fully fastened.

When the output shaft 11 rotates, the rotational force is transmitted to the interlock member 13 via the salient portions 12b and the depressed portions 13b engaging with the junction surface of the servo horn 12 and the junction surface of the interlock member 13. When the interlock member 13 is used as a human arm, the movement of oscillating the arm back and forth is performed.

When the robot having such a servo mechanism accidentally falls down, the interlock member 13 is often damaged due to a large external force applied thereto. If the interlock member 13 is not damaged, the reduction gear in the servo device may be damaged due to an impulse force to the output shaft 11.

However, according to the present invention, the interlock member 13 and the servo horn 12 are linked via the hemispheric portions 12b and the conical depressed portions 13b. The linking state is maintained by fastening the washer 14 having a slight resilient property. For that reason, when a certain strong impulse force of is applied, the linking between the salient portions of the servo horn 12 and the depressed portions of the interlock member 13 is released due to an instantaneous elastic deformation of the washer 14. Thus, the shifting of the linking position between the two elements allows the damage of the reduction gear to be prevented.

In the case of, for example, a hobby robot, the thickness of the washer 14 suitable for absorbing the external shock is set to be about 1 mm. However, the thickness may depend on the size of a robot or an anti-impulse force property. Namely, absorbing a strong impulse leads to increasing the washer thickness while absorbing a weak impulse leads to thinning the washer thickness.

In the present embodiment, each salient portion 12b on the servo horn 12 is hemispherical and each depressed portion 13b in the interlock member 13 is conical. However, the shape of the salient portion or depressed portion is not limited to only the embodiment. Any shape which can provide an effect identical to that of the present invention is acceptable. For example, in order to obtain the effect similar to that of the present invention, the salient portion may be hemispherical and the depressed portion may be pyramidal. In contrast, the servo horn 12 may have depressed portions, while the interlock member 13 may have salient portions.

As explained in the embodiment hereinabove, the servo horn 12 has hemispherical salient portions and the interlock member 13 has conical depressed portions. In this combination, since the contact surface between the two components becomes circular contact, the circular contact is not nearly changed even when hemispherical salient portions abrade away. Accordingly, the bonding force against impulse does not change over time.

As described above, when the linking state between the interlock member 13 and the servo horn 12 is released instantaneously by a strong impulse due to falling down, the relative positional relationship between the two elements changes. However, the linking mechanism of the present invention can be easily restored by slightly unscrewing the locking screw 15 press-engaging the serve horn 12 and the interlock member 13 and resetting the positional relationship of them to the original state and again securely fixing them with the locking screw 15.

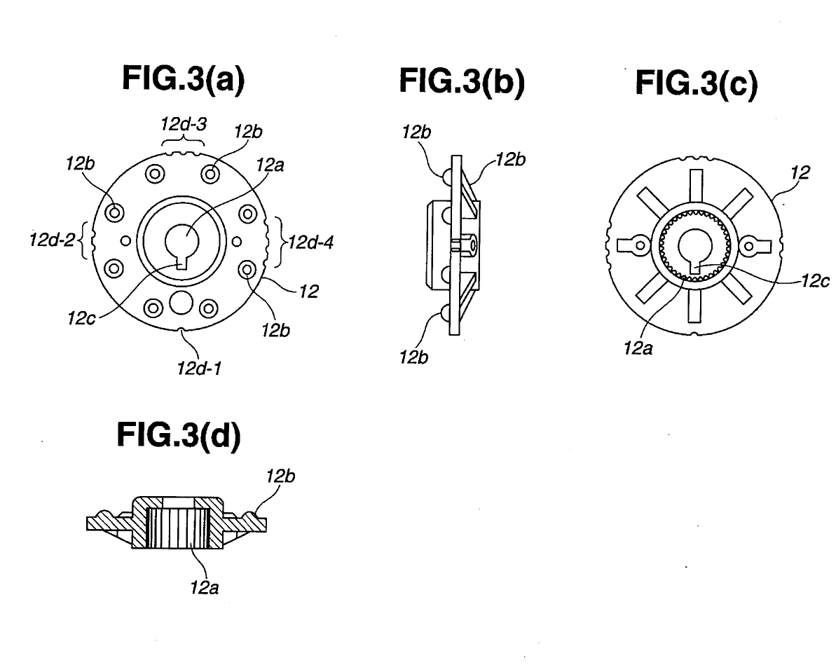

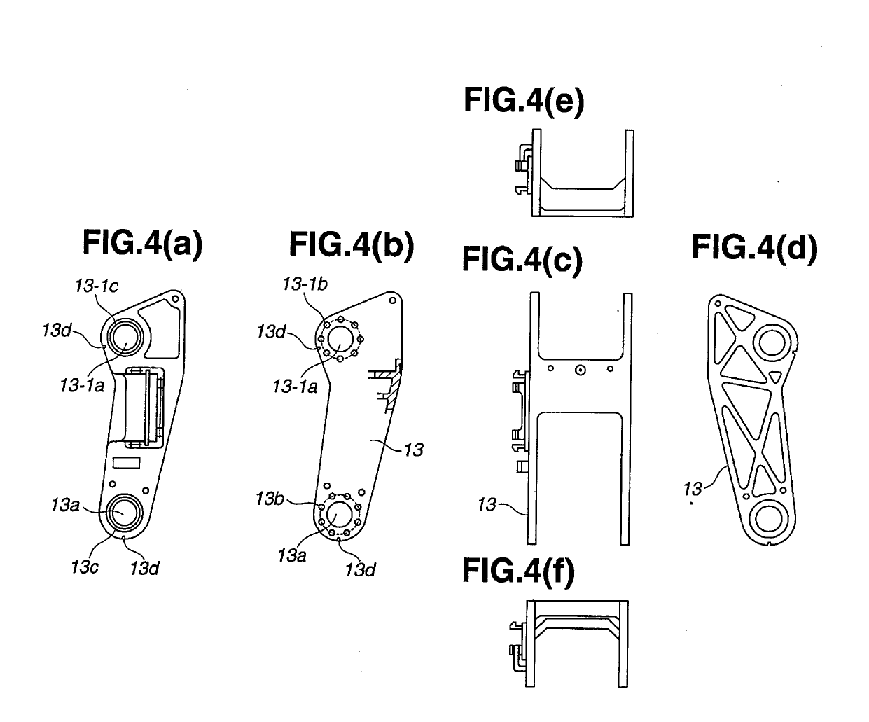

FIGS. 3 and 4 illustrate an example of the servo horn 12 and the interlock member 13, respectively. FIG. 3(a) is a front view illustrating the servo horn 12. FIG. 3(b) is a side view illustrating the servo horn 12. FIG. 3(c) is a rear view illustrating the servo horn 12. FIG. 3(d) is a cross-sectional view illustrating the servo horn 12.

FIGS. 3(a) and 3(b) show eight hemispherical salient portions 12b arranged circularly and an opening 12a in the center of the servo horn 12. A key hole 12c formed in a part of the opening 12a is provided to determine a relative position with respect to the output shaft 11. In an accurate positional relationship between the output shaft 11 and the servo horn 12, the mark 11c engraved on the end surface of the output shaft 11 can be seem from the key hole 12c. The rotational positions of the output shaft and the servo horn 12 are determined by matching the mark 11c with the key hole 12c.

In addition, turn marks 12_{d}-1, 12_{d}-2, 12_{d}-3 and 12_{d}-4, each having a different shape, are engraved, for example, at angles of 90° on the outer fringe of the servo horn 12. The turn mark 12d(1,2,3,4) facilitates the setting of the initial position to the interlock member 13.

FIG. 4 shows an example of the interlock members 13, in which FIG. 4(a) is a left outer side view, FIG. 4(b) is a left inner side view, FIG. 4(c) is a top view, FIG. 4(d) is a right outer side view, and FIGS. 4(e) and 4(f) are upper side views each illustrating the interlock member 13.

As shown in FIG. 4, the interlock member 13 has two openings 13a and 13-1a. The output shaft or other frame can be attached to the openings 13a and 13-1a via the servo horn 12.

At the positions engaging with the hemispherical salient portions 12b of the servo horn 12, eight conical recessed portions 13b or 13-1b are formed on the fringe of the opening 13a or 13-1a. The conical depressed portions 13b or 13-1b is coupled with the servo horn 12 so as to keep an anti-impulse property.

A position mark 13d is engraved on the outer fringe of the circularly arranged depressed portions 13b or 13-1b and at the position where the position mark 13d is overlapped with either one of the turn marks 12d(1,2,3,4). When the relative position between the servo horn 12 and the interlock member 13 is shifted due to the strong impulse, the locking screw 15 is loosened slightly. Then, the interlock member 13 is moved, while both the position mark 13d and the turn mark 12d(1,2,3,4) are being watched. Thus, the servo horn 12 and the interlock member 13 are reset to a normal initial position and then the locking screw 15 is tightened. Thus, the linked portion can be easily restored to the normal position.

The interlock member 13 can be used for various operational members, such as, hand, toe, elbow, knee, or shin, other than a frame or arm connecting two servo devices.

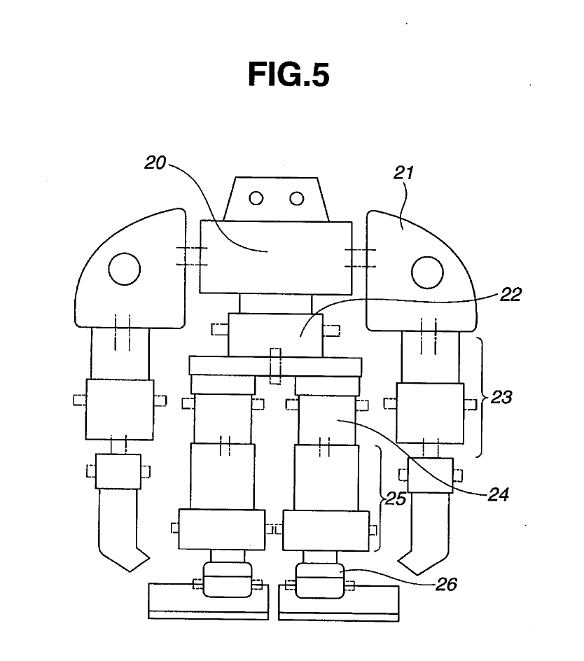

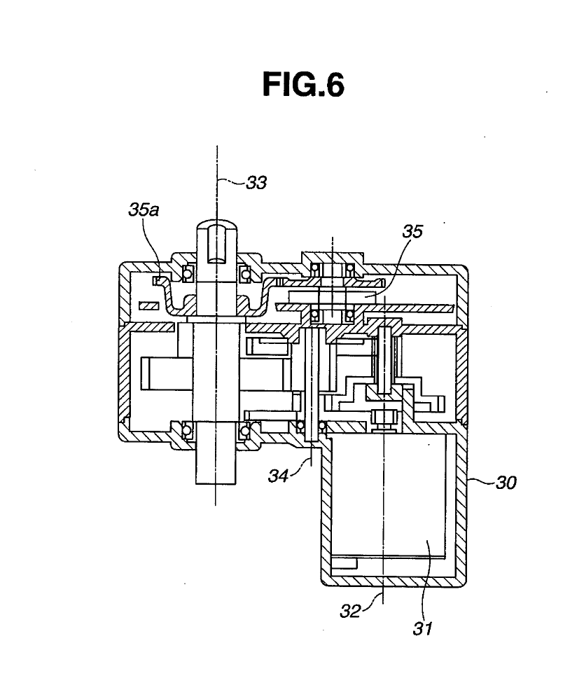

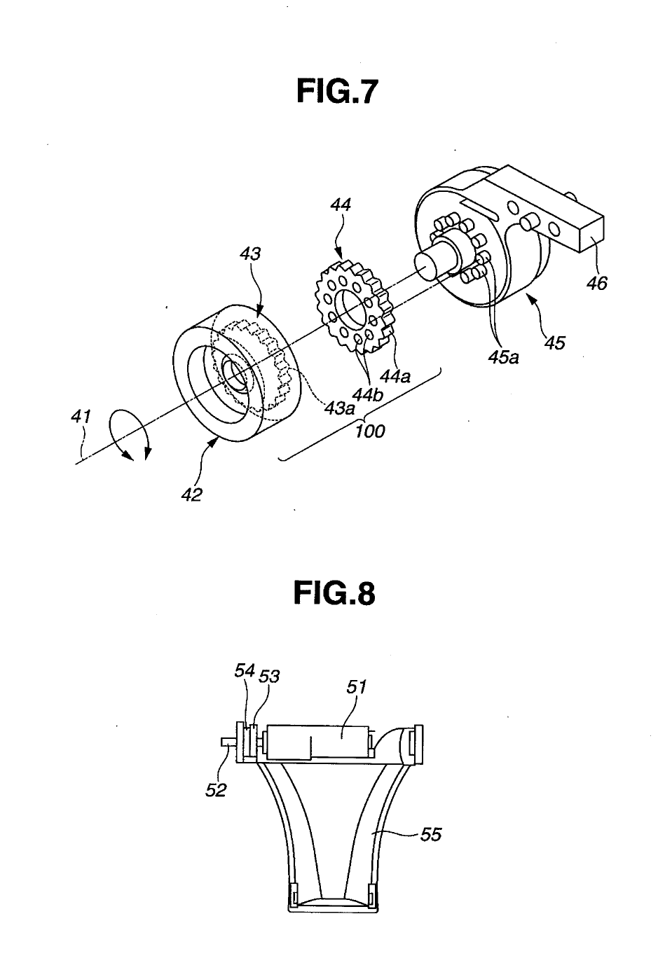

FIG. 5 schematically shows an example of a biped robot according to the present invention.

The biped robot comprises a head 20, a shoulder joint 21, a waist joint 22, an elbow joint 23, a crotch joint 24, a knee joint 25, and an ankle joint 26. A servo device having an output shaft, shown with chain lines, as well as an interlock member displacing rotationally with the servo device are employed in each joint.

A linking mechanism of the servo horn 12 and the interlock member 13 engaged with the output shaft as described above can be employed for all joints, in particular, for the shoulder joint or the waist joint.

In the shoulder joint 21, the waist joint 22 or the elbow joint, it is preferable to use a servo unit which displaces in two axial directions to provide rotation and displacement so that the robot can move more complicatedly and more smoothly.

The servo horn 12 and the interlock member 13 are coupled together with eight depressed portions 13b and eight salient portions 12b, which are arranged at even intervals. However, a part or all of the depressed or salient portions (12b or 13b) may be arranged at uneven intervals. This arrangement allows the structure to be easily restored to its accurate original positional relationship even when the relative positional relationship between the interlock member 13 and the servo horn 12 is displaced due to shock.

In the linking mechanism of interlock members for a robot according to the present invention, an anti-impulse characteristic can be provided with a robot by slightly modifying the junction surface between the interlock member and the servo horn. Moreover, the linking portion between the interlock member and the servo horn can be sold as assembling parts for robots. Thus, a biped robot having anti-impulse characteristics and facilitating its maintenance can be provided at relatively low prices.

Furthermore, the linking mechanism of the present invention is useful to make the robot as small as possible and reproduce complicated movements accurately with an increased number of joints.

While there has been shown and described what are at present considered the preferred embodiments of the invention, it will be obvious to those skilled in the art that various changes and modifications can be made without departing from the scope of the invention defined by the appended claims.

What is claimed is:

1. A linking mechanism of interlock members for a robot comprising:
a servo device;
a servo horn connected to an output shaft of said servo device; and
an interlock mechanism press-connected against said servo horn with a washer; wherein
a junction surface between said interlock member and said servo horn is press engaged with a depressed or salient portion disposed circumferentially or said junction surface.

2. The linking mechanism as defined in claim 1, wherein said depressed or salient portion comprises hemispherical salient portions formed on the outer junction surface of said servo horn and conical depressed portions formed on the inner junction surface of said interlock member.

3. The linking mechanism as defined in claim 1, wherein said washer member comprises a circular synthetic resin material.

4. The linking mechanism as defined in claim 1, wherein said servo horn and the interlock member are press fit with locking screws screwed into said output shaft through the center of the washer member.

5. The linking mechanism as defined in claim 1, wherein said interlock member comprises a frame or arm constructing a robot.

6. A biped robot having a linking mechanism of interlock members for a robot as defined in claim 1, wherein said linking mechanism is adapted for use in joints at predetermined positions in said biped robot.
